(19) United States
(12) Patent Application Publication
(10) Pub. No.: US 2021/0374843 A1
(43) Pub. Date: Dec. 2, 2021

(54) Debt Resource Management in a Distributed Ledger System

(71) Applicant: Mitsubishi Electric Research Laboratories, Inc., Cambridge (GB)

(72) Inventors: Uros Kalabic, Jamaica Plain, MA (US); Tsz-Chun Michael Chiu, Toronto (CA)

(73) Assignee: Mitsubishi Electric Research Laboratories, Inc., Cambridge, MA (US)

(21) Appl. No.: 16/882,845

(22) Filed: May 26, 2020

(51) Int. Cl. G06Q 40/02; G06Q 20/40; G06F 16/27; G06F 16/23

(52) U.S. Cl. CPC G06Q 40/02; G06F 16/2379; G06F 16/27; G06Q 20/401

(57) ABSTRACT

Disclosed a system and method of debt management in a distributed ledger system. The methods and systems provide for representing and assigning debt in the form of tokens in the distributed ledger. The debt tokens are implemented in a UTXO model by creating debt-only addresses that can send credit only with permission. The credit tokens are implemented based on UTXO model by requiring an input as well as an output specified for the credit transaction.

### TECHNICAL FIELD

This invention generally relates to distributed ledger systems, and more particularly to debt resource management in distributed ledger systems such as in blockchain.

### BACKGROUND

Digitalization of assets in the current era has led to the transformation of conventional systems in various domains. Such assets could include literary assets, entertainment-related assets, books, images, multimedia, knowledge, and especially financial and monetary assets. With the advent of disruptive technologies such as blockchain and digital wallets, even hitherto tangible assets such as money or currency are now being emulated in the digital domain. One such disruptive technology is the implementation of a digital token, which can be represented as a single digital unit that may be used to emulated tangible objects such as paper money, coins or any other unit of currency.

Digital tokens are units of exchange that emulate the behavior of hard currency, such as paper money or coins. Analogous to real world banking systems, a digital token may be associated with a digital token account. A digital token account in turn may be implemented through a digital ledger system. The digital ledger system or a digital ledger is a database or record of transactions stored in the memory of a system. Credit transactions and debit transactions are two types of transactions in the digital ledger. The credit transactions are positive additions to the digital ledger and debit transactions are negative additions to the digital ledger.

The digital ledger system may be implemented by different types of architectures. Broadly, the architectures may be classified into centralized architectures and decentralized or distributed architectures. The management of transactions in these different architectures may take place according to a centralized method or a decentralized method. The first method, i.e. the centralized method, is a common method that uses a centralized system that keeps a record of all the transactions in the system and changes this record without requiring the agreement of other systems with its own record. The second method is a decentralized or distributed method that allows multiple systems to keep a record of transactions and implements a method of reaching consensus among the systems regarding the most updated copy of the records, by using consensus algorithms to ensure byzantine fault tolerant replication between multiple nodes of the decentralized system. The distributed method is useful as it reduces the amount of trust a user has to place in the overall system due to the use of cryptography and consensus algorithms. Furthermore, the decentralized method reduces reliance on a single point of control and distributes the control of the system among multiple points of access, while at the same time ensuring the security of the system by the use of consensus. An example of the decentralized architecture system using distributed management of transactions is a distributed ledger system enabled by a data-structure called a blockchain.

The blockchain is an append-only data structure consisting of blocks linked together using a linked list structure or similar. A block contains information associated with digital data, including a header, metadata, and a list of transactions. The header and metadata can contain information about the software version, cryptographic hashes used to verify the integrity of the transactions contained in the block, timestamps and so on. The list of transactions contains individual transactions which represent changes in state of the distributed ledger system. A user in a blockchain system may be associated with a cryptographically generated address, henceforth referred to as “address”. Addresses can be used for transactions between users. In the blockchain, a credit balance may be associated with an address and it may simply be the sum of all incoming transactions to that address. A user may own multiple addresses in the distributed ledger system, in which case his personal balance is the sum of balances of all of his addresses.

One method of implementing transactions in distributed ledgers having the blockchain data structure is through the use of the unspent transaction output (UTXO) model. In the UTXO model, transactions may have inputs and outputs. Inputs to the transaction may include a pointer to UTXOs and an unlocking script. Outputs include amounts and the address of the user to which the corresponding amounts are being sent. If the transaction output in the UTXO model is not matched to the input of some subsequent transaction, the output is “unspent” and is treated as a spendable unit. Once the UTXO has been matched to a transaction input, it is deemed to be transferred or spent. A UTXO is therefore a transaction output without a corresponding input, i.e. it is unmatched and therefore available for spending. Therefore, a UTXO is in essence a credit that is assigned to some user; hence the sum of UTXOs in all addresses corresponding to the user is the account balance of that user.

However, the UTXO fails to represent a notion of debit. Notably, debits, which are determined through transaction inputs, do not exist in the blockchain without equivalent, corresponding credits, which are determined through transaction outputs. One notable exception is the creation of tokens, e.g., through mining, which occurs without the need for an input at all.

Conventionally, the UTXO can be part of a transaction having multiple output addresses. In the case the amount in the UTXO is greater than the amount required for the transaction, the UTXO sends its full amount to multiple addresses. A part of the transaction output amount covers the transaction and another part is sent to the same address or a newly generated address associated with the sender. Therefore, conventionally, each transaction input is matched to a transaction output. Accordingly, debits which are determined through transaction inputs do not exist without equivalent corresponding credits, which are determined through transaction outputs.

Traditionally, in a centralized system, debit entries do exist on their own and are commonly termed liabilities in double-ledger accounting. The existence of this negative money is a necessity for the functioning of a complex economy as it represents debt. On the contrary, most distributed ledgers implement currency and currencies cannot be negative. Importantly, most successfully implemented distributed ledgers are implemented with the assumption of no coercion. Without coercion, one cannot ensure the repayment of debts. The issuance of debt without coercion would result in account balances blowing up in the negative, giving the distributed ledger no value. This aspect is easy to remedy through the implementation of a ledger in a centralized system. A centralized system can be designed to work with the overall legal system, for example, to ensure the regulation and repayment of debts. But, there is seemingly no way to reconcile the need to ensure repayment of debts and the common way in which distributed ledgers work.

Accordingly, there is a need to represent value of debt in a distributed manner, such as in the distributed ledger system having a blockchain data structure, without relying on a reserve of digital tokens held by a centralized system.

### SUMMARY

It is an object of some embodiments to provide a system and a method to represent the value of debt in a distributed manner without relying on reserves held by a centralized system. Additionally, or alternatively, it is an object of some embodiments to provide a system and a method to ensure the regulation and repayment of debts in a coercive manner.

Some embodiments are based on the understanding that the notion of debit can be created atop of the blockchain protocol. For example, two blockchains can be created, one for positive tokens (also known as credits) and one for negative tokens (also known as debits). Additionally, the notion of credits can be created with the help of smart contracts. However, such a double ledger system or smart contract extension is inconvenient and adds potentially undesirable reliance on third party software.

To that end, it is an object of some embodiments to provide a blockchain protocol that is suitable for the creation of both credit and debit transactions. Additionally, or alternatively, it is an object of some embodiments to provide such a blockchain protocol that can be combined with or extend the legacy UTXO model.

Some embodiments are based on the realization that if the notion of credits in the UTXO model is structured based on unmatched outputs of the transactions, the notion of debits in the extended UTXO model can be structured based on transactions with unmatched inputs. In other words, while credit is a transaction with inputs and unmatched outputs, debit is a transaction with outputs and unmatched inputs. In such a manner, the debt transactions can be naturally integrated into the UTXO model.

Notably, the coinbase transaction for creating a credit through mining does not have an input. However, the debt transaction has an input, but the input is unmatched. The difference between having no input and having an unmatched input is evident from the fact that the blockchain protocol allows to match the unmatched input, but does not allow to match or add the input into the coinbase transaction. In such a manner the protocol allows to cancel the debt (or paying the debt) by simply matching the input to the output of credit transaction. Such a payment would be impossible in the coinbase transaction.

The introduction of debt transaction based on unmatched inputs integrates the debt and credit transaction into a single protocol. The direct representation of debt within the protocol improves the integrity of the protocol. Alternative methods of implementing debt introduce additional complexity, which decreases the usefulness of the protocol and creates more potential for failure.

In addition, the integration of debt and credit transactions provides an alternative to credit creation/mining based on the proof of work concept. In some implementations of the integrated distributed ledger, the credit creation transaction can be generated if somebody is willing to take a debt for such generation. In such a manner, the credit creation is validated by a creditor.

Some embodiments are based on a distributed ledger that implements a debt-and-credit system via the introduction of a debt token. The value to the system is ensured by the willingness of a user to take on a debt. Thus the system creates a credit token balance and a simultaneous debt token balance of equal amount. To that end, some embodiments are based on the objective of creating an integrated yet distributed manner in which debt can be created. The repayment of the debt is achieved in a coercive manner.

Some embodiments are based on introducing a new debt-issuance transaction. The debt is implemented by introducing debt-only addresses, which are addresses that can send amount without having associated UTXOs. In the debt-issuance transaction, a transaction is created whose transaction input points to a debt-only address and whose unlock script holds a public key that ensures permission to take on debt. This replaces the creation transaction in the UTXO model, and creates tokens by introducing transactions with unmatched input fields. When processing a debt-issuance transaction, the protocol does not check for a UTXO. It instead checks for permission that a creditor user is allowed to issue debt to a debtor user.

Some embodiments are based on the creation of tokens. When the system issues a debt token, it always issues a corresponding credit token; any amount of debt tokens that is issued is issued with a corresponding amount of credit tokens. The creation of tokens is done by creating a UTXO which is owned by a creditor user. And the creation of UTXO is achieved by debiting a debt-only address which is owned by a debtor. This ensures that at all times the amount of credit and debit in the system is equal, avoiding the creation of credit or debit by fiat without willingness of a party to take on debt. Debt-only addresses can send credit only through a debt-issuance transaction. This ensures that debts cannot be accrued, and credit tokens cannot be created, without permission from the protocol.

In this way, debt tokens are created in debt-only addresses and cannot be moved. Further, the creation of debt tokens and credit tokens in this manner ensures that users receive debts that need to be enforced and paid, and therefore the ability to programmatically send away debts is not allowed. This is naturally enforced by the protocol described above as will be discussed in the various embodiments described herein.

Some embodiments describe the creation of debt tokens and credit tokens. As will be described in more detail in various embodiments, credit tokens can be moved freely. Furthermore, debt tokens can be destroyed by sending a credit transaction and/or credit tokens with a debt-only address in the transaction output. The amount of credit tokens sent to a debt-only address destroys an equal amount of debt tokens held at that address. Structurally, the transaction to pay debt mimics a credit transaction. The credit tokens sent to debt-only addresses ensure that debt-only addresses do not have a negative balance. Therefore, if a credit transaction is initiated to send more than the maximum amount to a debt-only address, a transaction with a UTXO is created and the difference between the sent amount and the maximum amount is stored in the UTXO.

Some embodiments describe the management of a debt pool for the accounting of debts to users in the distributed system. The debt pool may store debt tokens, that may be issued to a user as needed, and that are destroyed when the debt is repaid, such as by sending credit tokens equivalent in amount to the amount of debt, to the debt pool.

Some embodiments describe a blockchain protocol stack for management of debt in the distributed ledger system using the debt tokens and credit tokens. The blockchain protocol may implement the various transactions as described earlier through the distributed ledger system architecture as described in some embodiments.

### BRIEF DESCRIPTION OF THE DRAWING

The presently disclosed embodiments will be further explained with reference to the attached drawings. The drawings shown are not necessarily to scale, with emphasis instead generally being placed upon illustrating the principles of the presently disclosed embodiments.

FIG. 1A shows a schematic of a distributed ledger system according to some embodiments.

FIG. 1B shows an example of the structure of a transaction in a UTXO-based model.

FIG. 1C shows an example of the transaction input data structure.

FIG. 1D shows an example of the transaction output data structure.

FIG. 2 shows an example of an Unspent Transaction Output (UTXO).

FIG. 3A shows an example of a debt transaction.

FIG. 3B shows an example of an unspent debt-credit transaction.

FIG. 3C shows a debt transaction that has been partially repaid.

FIG. 4A shows an example of a debt transaction with flags.

FIG. 4B shows an example of a coin base transaction with flags.

FIG. 5A shows an example of debt transactions in the debt pool.

FIG. 5B shows the creation of a debit simultaneously with a credit transaction.

FIG. 6A shows an example of a blockchain block structure according to some embodiments.

FIG. 6B shows an example of how to generate debt-only addresses from public keys.

FIG. 7 shows an exemplary diagram illustrating a blockchain protocol stack for implementing debt management in a distributed ledger system.

FIG. 8 shows a block diagram of distributed ledger system architecture according to some embodiments.

FIG. 9 shows a block diagram of the distributed ledger system of FIG. 9 according to some embodiments.

FIG. 10 shows an exemplary architecture of the distributed ledger system with debt management according to some embodiments.

FIG. 11 shows an exemplary block diagram of a method for debt management in a distributed ledger system according to some embodiments.

FIG. 12A shows an exemplary block diagram of the sequence of events that occur in embodiments of blockchain systems with coinbase transactions that are accepted by the network.

FIG. 12B shows an exemplary block diagram of the sequence of events that occur when a debt transaction is generated.

FIG. 12C shows an exemplary block diagram of the sequence of events that occur when a debt is paid.

FIG. 12D shows an exemplary block diagram of the sequence of events that occur when a debt transaction is completely paid off or greater than the debt amount.

### DETAILED DESCRIPTION

The present disclosure relates to a method to implement a debt-and-credit system used in distributed or decentralized ledger system architectures. Some embodiments of the present disclosure are based on an Unspent Transaction Output (UTXO) model. The UTXO model is used to provide a UTXO-based distributed ledger system in which credit transactions are underpinned by debts, so that the total sum of credit in the system is equal to the sum of debt in the system. The relationship between credit and debit in the system in this manner ensures that the creation of a credit is only possible with the simultaneous creation of an equal debt.

In a UTXO-based system, participants in the network may interact with each other by sending transactions to one another. This is, in part, facilitated by public-private key cryptography. Each participant is represented by a private key in the system from which a corresponding public key can be generated. In some embodiments, a master private key can generate many child private keys, each in turn having an associated public key. The use of cryptography and public-private key pairs is used to provide a secure system architecture. The current UTXO based systems with cryptography enabled features are still not able to provide efficient representation of debt in the system because of the lack of existence of debt transactions and efficient debt management procedures. In the UTXO based systems, UTXOs are transactions without any transaction outputs. The UTXOs can thus be considered as unspent units of resources, such as currency or unspent money available to a user for spending in the system. For example, like a real-world user carries cash in a wallet or maintains money in their account for spending during various transactions, similarly a UTXO is the user's unspent money or credit in the distributed ledger system. Transactions represent the assignment and reassignment of credit. This is not to say that the UTXO structure is limited to the representation of monetary value. UTXO-based systems can represent other types of immutable data, such as, for example, an individual's identity, units of energy, and/or various goods available in a chain of stores and tracked by block-chain based resource management system.

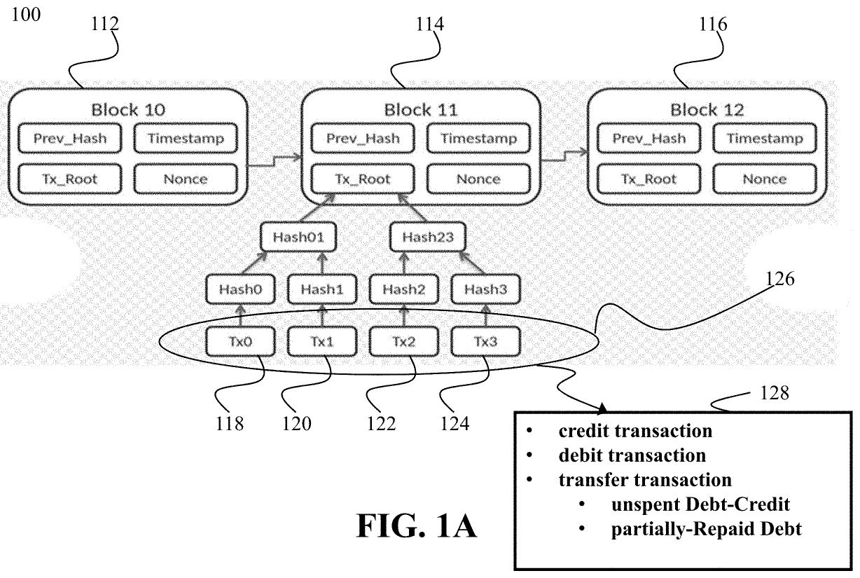

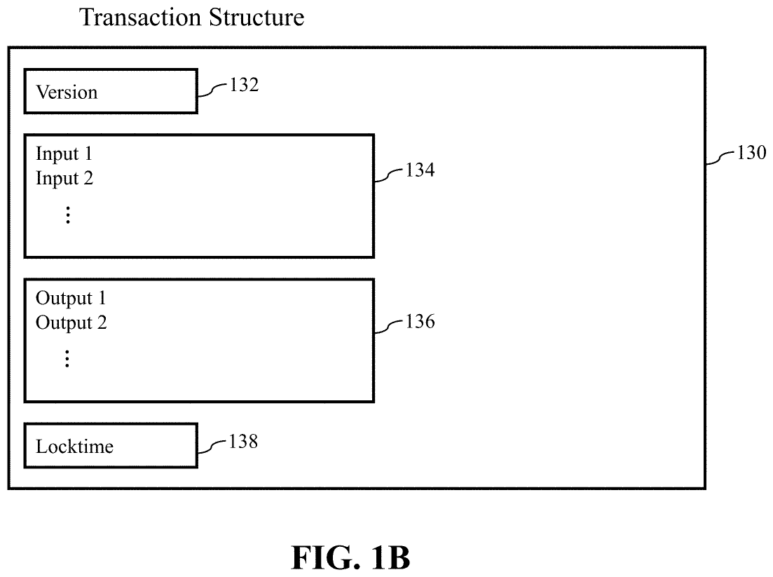

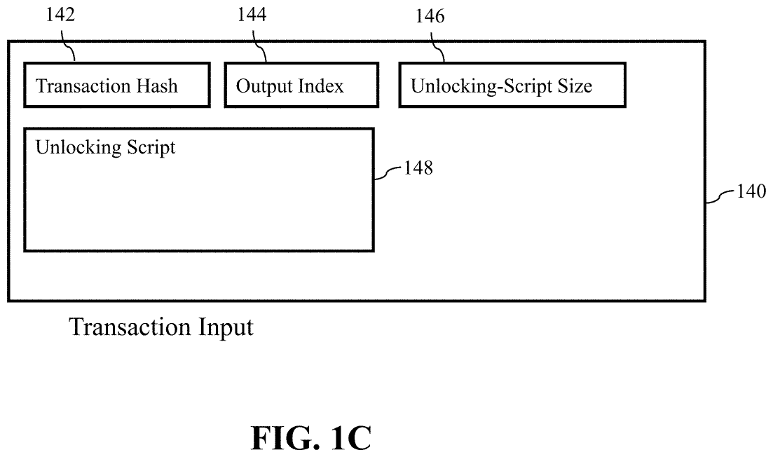

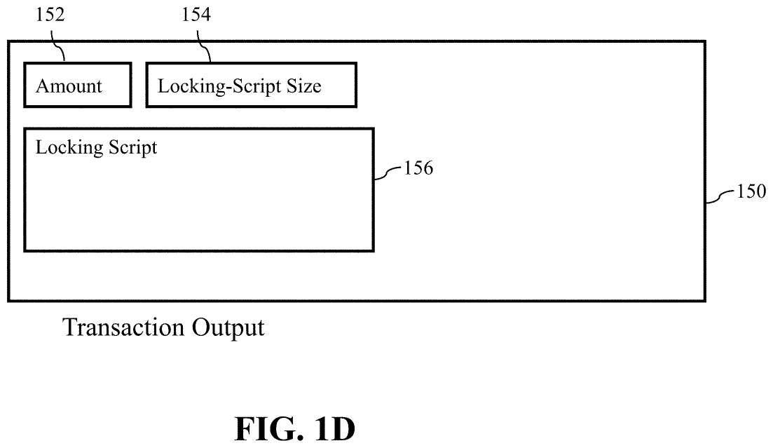

FIG. 1A shows a schematic of a distributed ledger system 100 according to some embodiments. In various embodiments, the distributed ledger system 100 implements transactions in distributed ledgers having the blockchain data structure. To that end, the distributed ledger system 100 includes at least one processor configured to execute a blockchain protocol for receiving messages and processing those messages into one or more blocks 112, 114, and 116 of a blockchain. The one or more blocks 112-116 may further be connected to a plurality node in the distributed ledger system 100, wherein a node may be a building block of an entire network using the blockchain protocol. The plurality of nodes may be interconnected with each other, in such a manner that each node is connected to every other node in the network. Further, each node may be configured to contain their own copy of the entire blockchain represented using the blockchain protocol in the distributed ledger system 100. Further, each node may be embodied in a plurality of ways, including but not limited to such as a computer, a mobile device, a handheld, a portable computing device, a tablet, a smartphone, a laptop, a smart wearable device and the like. Each node may be configured to have a consensus based copy of the blockchain formed by the one or more blocks 112-116.

Each block in the blockchain may comprise a plurality of fields including a hash field, a timestamp field, a transaction root field and a nonce field. The hash field may include a cryptograph hash function, such as the SHA256 cryptographic hash algorithm, created on the header of each block. Each of the one or more 112-116 blocks may include a reference to the hash of the previous block. Each of the one or more blocks 112-116 further include the timestamp field which describes a time when the block was built or created. Each block may further include the transaction root, which comprises root of a Merkle tree associated with the block, The Merkle tree is a binary hash tree that may be used for validating the data of each block. The transaction root may include a hash of the root of each block's transaction, such as transactions 126. Each block may further include a nonce (number only used once) field, which may be a counter that may be used solving a difficulty target algorithm associated with the block. For example, the nonce may be used in solving the difficulty target algorithm by the block. In some embodiments, the difficulty target algorithm may be the Proof-of-Work (PoW) algorithm used in the blockchain, by one or more blocks 112-116 of the blockchain.

A blockchain is a decentralized, distributed, and oftentimes public, digital ledger that is used to record transactions across many computers so that any involved record cannot be altered retroactively, without the alteration of all subsequent blocks. This allows the participants to verify and audit transactions independently and relatively inexpensively. A blockchain database is managed autonomously using a peer-to-peer network of the plurality of nodes and a distributed timestamping server. They are authenticated by mass collaboration powered by collective self-interests. Such a design facilitates robust workflow where participants' uncertainty regarding data security is marginal. The use of a blockchain removes the characteristic of infinite reproducibility from a digital asset. It confirms that each unit of value was transferred only once, solving the long-standing problem of double spending.

In various embodiments, the blockchain protocol is implemented through the use of the UTXO model. To that end, a message is associated with a transaction 126 to be included in the blockchain by matching inputs and outputs of the transaction to neighboring transactions 126 such that an input of the transaction is matched to an output of a previous transaction and an output of the transaction is matched to an input of a next transaction. During processing of the messages, the processor is configured to generate different types 128 of the transaction including a credit transaction 118 having an unmatched output configured for matching to the next transaction; a debit transaction 120 having an unmatched input configured for matching to the previous transaction and a transfer transaction 122 having a matched input and a matched output. The transfer transaction 122 can be of different types, such as unspent debt-credit transaction and/or partially-repaid debt transaction, and others. In some implementation, the different types 128 of the transaction can optionally include a coinbase transaction 124.

It is an object of some embodiments to provide a system and a method to represent the value of debt in a distributed manner without relying on reserves held by a centralized system. Additionally, or alternatively, it is an object of some embodiments to provide a system and a method to ensure the regulation and repayment of debts in a coercive manner.

Some embodiments are based on the understanding that the notion of debit can be created atop of the blockchain protocol. For example, two blockchains can be created, one for positive tokens (also known as credits) and one for negative tokens (also known as debits). Additionally, the notion of credits can be created with the help of smart contracts. However, such a double ledger system or smart contract extension is inconvenient and adds potentially undesirable reliance on third party software.

To that end, it is an object of some embodiments to provide a blockchain protocol that is suitable for the creation of both credit and debit transactions. Additionally, or alternatively, it is an object of some embodiments to provide such a blockchain protocol that can be combined with or extend the legacy UTXO model.

Some embodiments are based on the realization that if the notion of credits in the UTXO model is structured based on unmatched outputs of the transactions, the notion of debits in the extended UTXO model can be structured based on transactions with unmatched inputs. In other words, while credit is a transaction with inputs and unmatched outputs, debit is a transaction with outputs and unmatched inputs. Such transactions with outputs and unmatched inputs may be referred to as debt transactions in the distributed ledger systems configured for implementing these transactions. In such a manner, debt transactions can be naturally integrated into the UTXO model. The introduction of debt transaction based on unmatched inputs integrates the debt and credit transaction into a single protocol. The direct representation of debt within the protocol improves the integrity of the protocol. Alternative methods of implementing debt introduce additional complexity, which decreases the usefulness of the protocol and creates more potential for failure.

To that end, the structure of the transactions takes advantage from input/output relationships. For example, a credit transaction is generated to have an unmatched output configured for matching to the next transaction. In a similar manner, a debit transaction is generated to have an unmatched input configured for matching to the previous transaction. A transfer transaction is generated to have a matched input and a matched output. The transfer transaction can connect credit to debit transaction and vice versa.

For example, as used herein, a credit transaction having an unmatched output configured for matching to the next transaction means that the distributed ledger system 100 stores an executable code that when executed by the processor (after the credit transaction has been added to the blockchain) generates another transaction having input pointed to the output of the credit transaction. This transaction is referred herein as the next transaction, because it is created later than the credit transaction and is connected to the credit transaction through its output, i.e., in a manner indicated by UTXO as subsequent connection.

As used herein, a debit transaction having an unmatched input configured for matching to the previous transaction means that the distributed ledger system 100 stores an executable code that when executed by the processor (after the debit transaction has been added to the blockchain) generates another transaction having output pointed to the input of the debit transaction. This another transaction is referred herein as the previous transaction, even if this previous transaction is added to blockchain after the debit transaction. This is because that previous transaction is connected to the debit transaction through its input, i.e., in a manner indicated by UTXO as preceding connection. In such a manner, the debt transactions are integrated to the blockchain protocol that can be combined with or extend the legacy UTXO model.

FIG. 1B shows an example of the structure of a transaction 130 in a UTXO model based system. The structure of this exemplar transaction includes of a version number 132, which allows for the network to handle different valid versions of the blockchain protocol. It also includes inputs 134 and/or a container of transaction inputs 134, which are data structures used to point to a UTXO, denoting a source of credit, as will be described in more detail in FIG. 1C. It also includes outputs 136 and/or a container of transaction outputs 136, which are data structures used to transfer credits to another recipient in the form of a locking script. The structure of this exemplar transaction 130 also includes a locktime 138, which specifies the earliest time a transaction can be added to a system, such as to the distributed ledger system. In some embodiments, the distributed ledger system is a blockchain system, such as the distributed ledger system 100 based on the blockchain protocol described in association with FIG. 1A. In such a blockchain system, the locktime 138 can be time in a Unix Epoch timestamp or a block height, which represents the number of blocks that must be in the blockchain before the transaction can be considered for inclusion into a block, such as in the one or more blocks 112-116 described in conjunction with FIG. 1A. In some embodiments, the locktime 138 may be defined on the basis of a consensus among different nodes in the blockchain system regarding which copy of the distributed ledger should be used to update a block of the blockchain. In such a case, the longest sequence of blocks may be selected as the most updated copy of the blockchain and the locktime 138 may be updated based on the longest sequence of blocks. The blockchain system may be used to carry out the transactions as defined by the transaction structure 130. The transaction structure 130 may now be described more fully in conjunction with FIG. 1C.

FIG. 1C shows an example of a transaction input data structure 140, such as the transaction inputs 134 described in FIG. 1B. The transaction input data structure 134 may include a transaction hash 142, which may include a pointer to the transaction containing a UTXO to be spent. The transaction input data structure 140 further includes an output index 144, wherein the output index 144 comprises an index number of the UTXO to be spent. The transaction input data structure 140 further includes a field for specifying an unlocking-script size 146, which may be used to specify the size of the unlocking script, in bytes. Further, the transaction input data structure 140 further includes an unlocking script 138, which includes a script that fulfills the conditions of the locking script of the UTXO to which the pointer in the transaction hash 132 points. The unlocking script 148 that may be used to specify the conditions for spending of the UTXO associated with the transaction input data structure 140. The combination of the unlocking script 148 and a corresponding locking script, as will be explained in conjunction with a transaction output provided in FIG. 1D, is used to validate the transaction associated with the transaction input data structure 140. Specifically, the unlocking script 148 may be executed alongside a locking script to validate that the transaction meets the conditions specified in the unlocking script 148 for spending of the UTXO. Some examples of the unlocking scripts may include P2PKH (Pay to Public Key Hash) or a P2SH (Pay to Script Hash). These unlocking scripts are used to specify a cryptographic puzzle, which may be needed to be solved in order to spend the UTXO associated with the transaction input data structure 140. For example, the P2PKH unlocking script may specify a hash of public key usually the address of a payee, which the owner of the public key possessing the private key can correctly solve. The locking script that may be used to validate the unlocking script is found in a corresponding transaction output data structure, such as the transaction output data structure illustrated in detail in FIG. 1D.

FIG. 1D shows an example of a transaction output data structure 150, such as the transaction output data structure 136. It includes an amount 152, in bytes, of the value being sent. The amount 152 is some amount of digital currency less than or equal to the available amounts in the transaction inputs. Some embodiments may specify amounts in terms of digital tokens. The transaction output data structure 150 also includes a field specifying a locking-script size 154, the size of the locking script, in bytes. The transaction output data structure 150 also includes a locking script 156 specifying conditions that need to be met in order for the amount to be spent. The locking script 156 and the unlocking script 148 may be executed together to validate the UTXO defined by the transaction input 140 and transaction output 150.

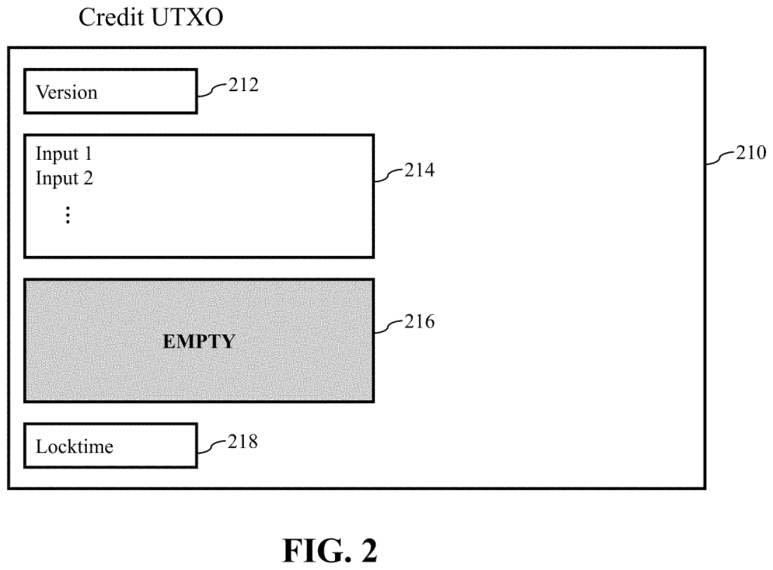

FIG. 2 shows an example of a UTXO 210. UTXOs are transactions without transaction outputs, so the transaction structure for the UTXO 210 has an empty transaction output 216. In a UTXO, there is no specified recipient and no locking script, and this means that the transaction is a potential credit that could be spent. UTXOs are held in a transaction pool, also commonly referred to as a memory pool, which is an in-memory container of all UTXOs in the system. In UTXO-based systems, memory pools denote the total available credit for spending (or reassignment) in the system. UTXOs live in the memory pool and not in the blockchain since they do not yet record the assignment of credit. The UTXO transaction structure 210 may additionally include other fields such as version number 212. The UTXO 210 also includes an input field 214 which may include one or more inputs and represents the amounts consumed by a transaction, such by one or more transactions 127, and thus in a way the amount of currency or credits or currency tokens available for spending in the UTXO 210. The UTXO 210 also includes a locktime field 218 which defines the earliest time that a transaction can be added to a system, such as to a distributed ledger system or a blockchain.

In addition to the above transactions, the UTXO-based systems include coinbase transactions, such as coinbase transactions 124, which are the first transactions in each block of a blockchain system. These are transactions without any inputs that are included in the blockchain; they do not exist in any form of memory pools. Coinbase transactions are the mechanism by which the blockchain system and its associated protocol rewards miners for successfully validating a block; miners are participants in the blockchain system that propose valid blocks for inclusion into the blockchain and obtain a reward if their block is accepted by the protocol. Coinbase transactions record the rewards received by the miners in the blockchain. Coinbase transactions do not have any inputs, but have outputs, and are included and recorded in blocks in the blockchain. Apart from coinbase transactions, the distributed ledger system disclosed by different embodiments provides for another type of transaction called the debt transaction. In some embodiments, the distributed ledger system may include both debt and coinbase transactions. This can be resolved by introducing flags fCoinbase and fDebtTrans, which hold the values 0 and 1, respectively, when the transaction is a debt transaction, and hold the values 1 and 0, respectively, when the transaction is a coinbase transaction

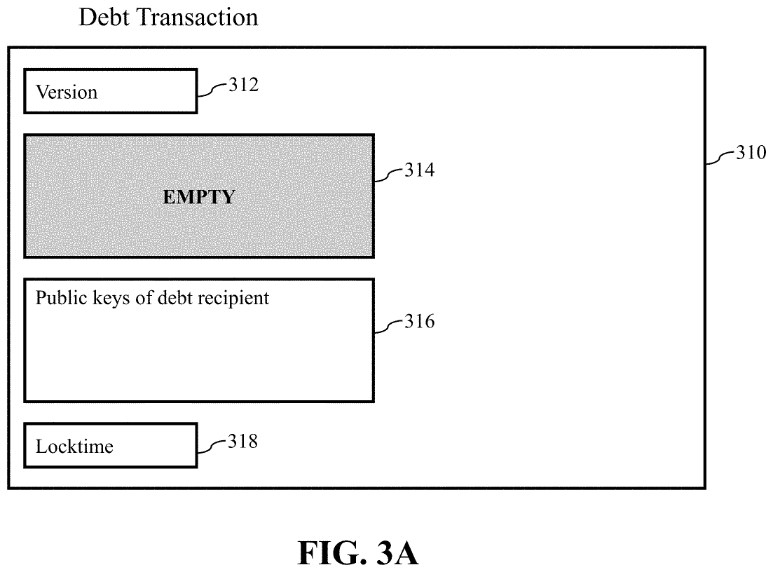

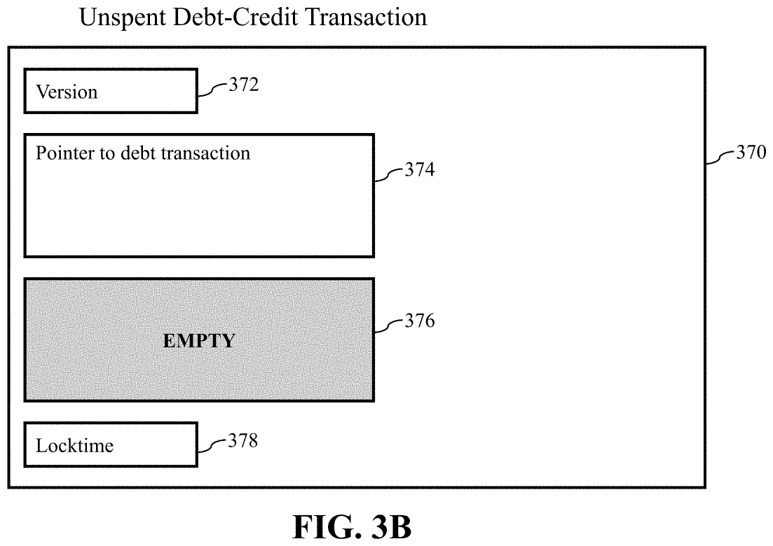

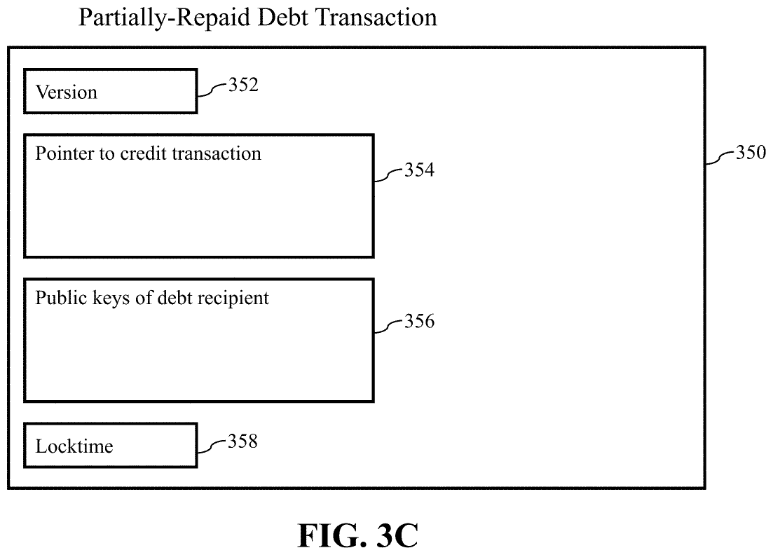

FIG. 3A shows an example of a debt transaction structure 310. As previously discussed, the debt transactions are implemented by the notion of credit transactions with unmatched outputs and debit transactions with unmatched inputs in the extended UTXO model based distributed ledger systems. To that end, the debt transaction structure 310 includes a version number field 312 and a locktime field 318 which are similar to the version 132 and locktime 138 fields discussed earlier in conjunction with FIG. 1B. The debt transaction structure 310 also includes an input field 314 which is initially unmatched. As discussed in conjunction with FIG. 1B, the input field 314 is generally used to identify the parent of a current transaction, that is to say, the source of credit in a transaction. The input field 314 of the debt transaction structure 310 is unmatched, thus, a debt transaction represented by the debt transaction structure 310 may be used to send credit to an intended recipient without the need of having sufficient credit available at a parent source.

Further, in some embodiments, a debt transaction involves creation of a credit transaction simultaneously alongside the debt transaction with an equal amount. This transaction is called a debt-credit transaction. The transaction input of a debt-credit transaction points to the originating debt transaction from which the credit was created. The output of the debt-credit transaction is kept unmatched. Since they have a transaction input and unmatched transaction outputs, debt-credit transactions are treated as a UTXO by the blockchain protocol and can be spent by the debtor in the usual manner, by recording the intended recipient, in the form of an address, in the locking script of the transaction output. Debt-credit transactions are broadcast to the network like credit transactions and are added to the memory pool by the blockchain protocol.

FIG. 3B shows an example of an unspent debt-credit transaction 370. The transaction structure 370 shows an input field 374 having a pointer to the debt transaction with which the credit transaction was created. The unspent debt-credit transaction also includes the version 372 and locktime 378. An output field 376 of the unspent debt-credit transaction 370 is empty. The debt-credit transaction 370 possess the same transaction structure as a credit UTXO 210, thus, the protocol handles it in the same manner.

Another type of transaction in distributed ledger systems disclosed herein is partially repaid debt transactions, such as already discussed in conjunction with different types of transactions 128 in FIG. 1A, as illustrated in FIG. 3C. Partial repayment of debts occurs when the credits sent by the debtor are less than the original amount of debt. The mechanism for repayment, whether partial or full, consists of assigning UTXOs to the inputs of the debt transaction. That is, the debtor sends UTXOs to the debt transaction by specifying the transaction hash of the owed-to debt transaction in the locking script of the credit (repayment) UTXO. The credit repayment transaction is broadcast to the network. Each node, upon receipt of the credit repayment transaction, in validating the transaction, checks the locking script to determine whether the address matches the hash of a debt transaction in its debt pool. If so, the protocol replaces the locking script of the credit (repayment) UTXO with the debt-only address and records the credit-repayment UTXO as an input to the debt-transaction from which the credit ultimately originated.

FIG. 3C shows a debt transaction that has been partially repaid as having partially repaid debt transaction structure 350. The partially repaid debt transaction structure 350 includes a version field 352, a pointer to credit transaction field 354 or an input field 354 that is not empty and points to a credit transaction, a field for public keys of debt recipient 356 and a locktime field 358. The version 352 and locktime 358 fields have the same function as previously discussed.

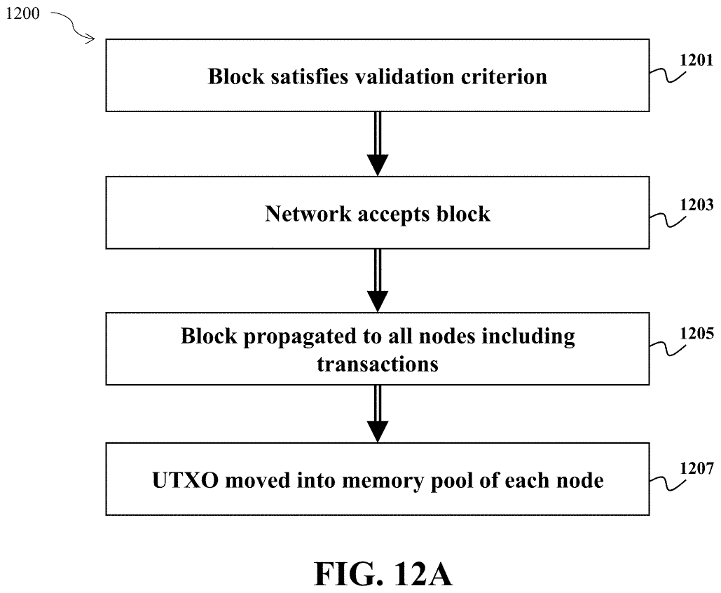

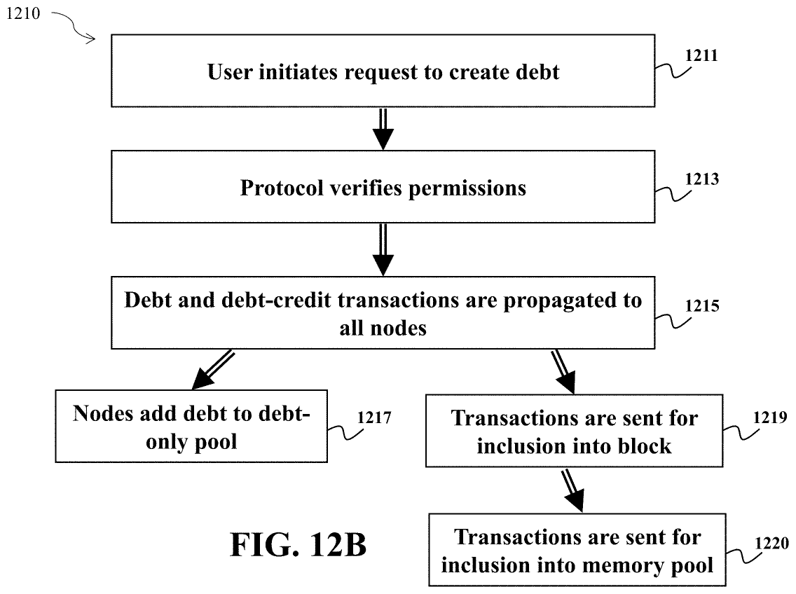

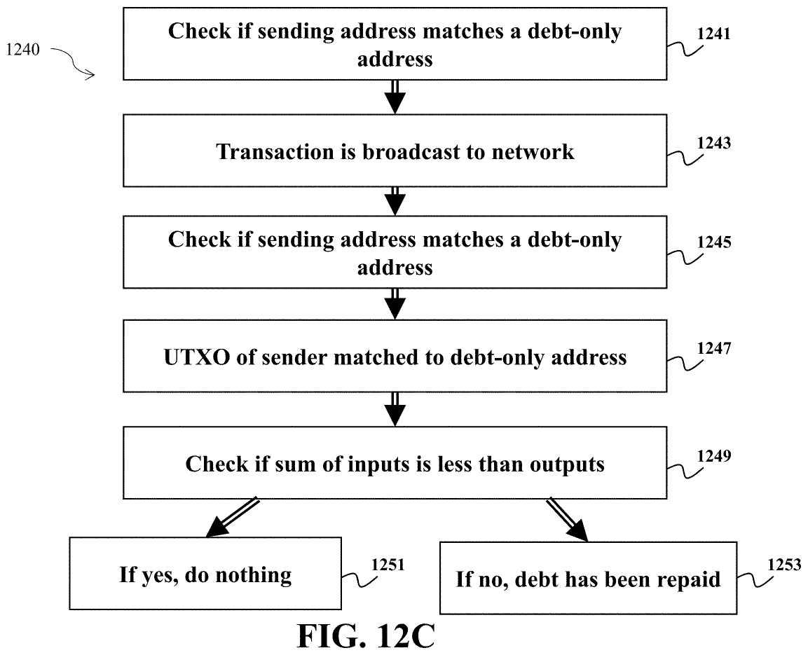

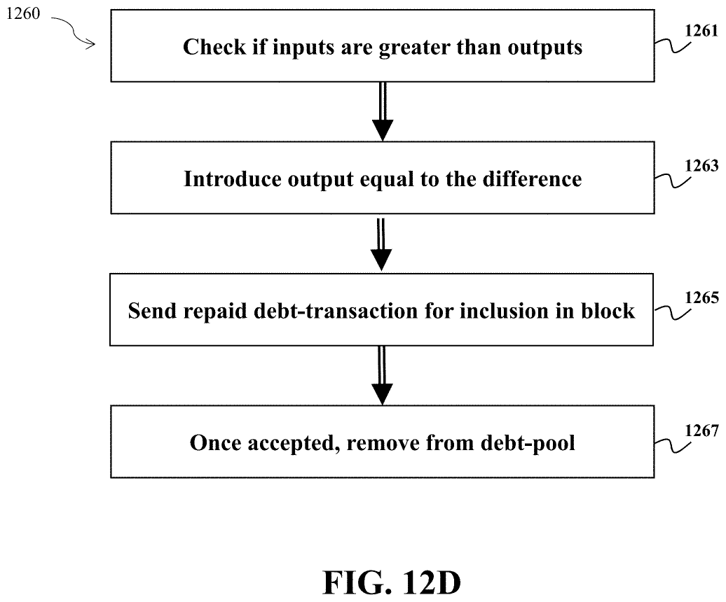

In the input field 354 of the partially repaid debt transaction structure 350, if the payment is partial, the locking script of a credit repayment UTXO gets replaced with an originating debt-only address and is then broadcast for validation and inclusion into one or more blocks 112-116. The input 354 of the partially repaid debt transaction 350 is then updated in the manner described above but remains in the debt pool. A debt is considered repaid if the sum of the transaction inputs and transaction outputs of the debt transaction are equal. This can be done by summing all the amounts of UTXOs referenced in the transaction inputs of the debt transaction and summing all the amounts in the transaction outputs of the debt transaction and checking that they are equal. If debt transaction is repaid, it is removed from the debt pool. The management of debts in the distributed ledger system in this manner will be described later in conjunction with FIGS. 12A-12D.

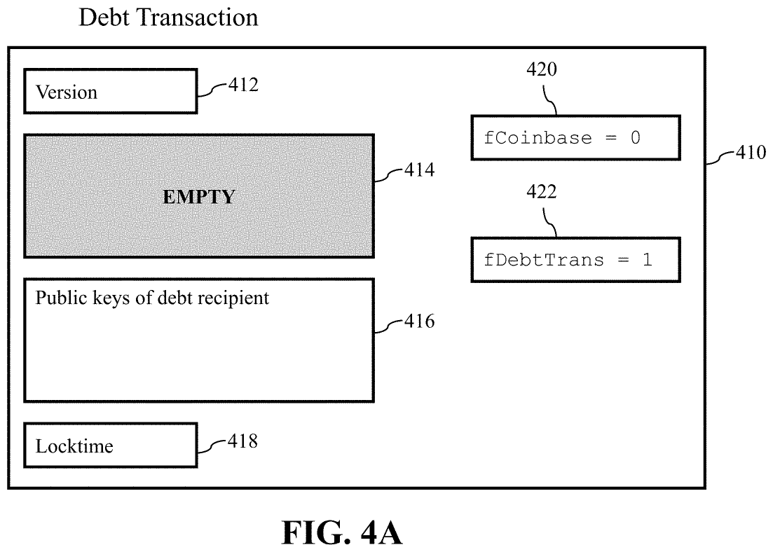

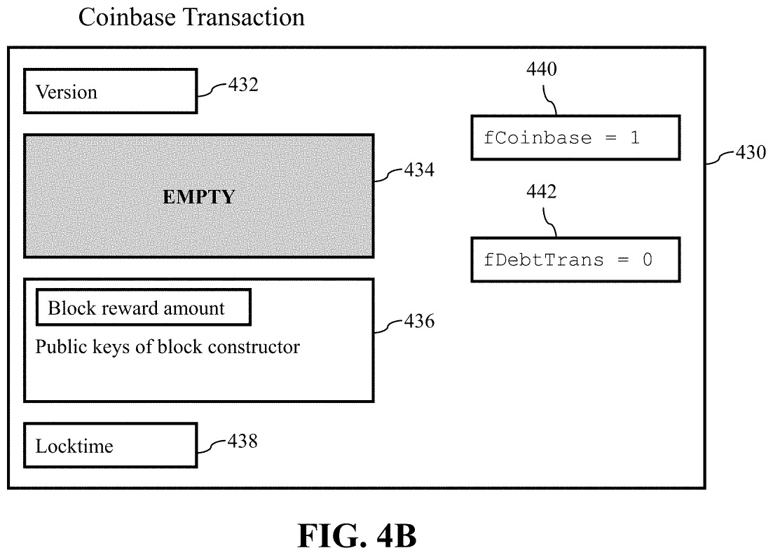

When debts are created via the generation of a debt transaction, such as will be discussed in the following FIG. 4A, the newly generated debt transactions are broadcast to other nodes and added to the debt pool. The debt-credit transaction that is generated simultaneously, is also broadcast to other nodes and added to the memory pool.

FIG. 4A shows a debt transaction structure 410 according to an embodiment of the blockchain protocol discussed above, that allows for both debt and coinbase transactions. The debt transaction structure 410 includes version field 412, a locktime field 418, an input field 414 which is empty, public keys of debt recipient 416 and two flags fCoinbase flag 420 and fDebtTrans flag 422. The fCoinBase flag is used for identifying whether this is a coinbase transaction. If the fCoinBase flag 420 is set to 0, the transaction is not a coinbase transaction. Additionally, or alternatively, the debt transaction 410 may include a flag, the fDebtTrans flag 422, to identify if a transaction is debt transaction or not. If fDebtTrans flag 422 is set to 1, the transaction is a debt transaction.

FIG. 4B shows a coinbase transaction structure 430 according to some embodiments. The coinbase transaction structure 430 includes a field version 432 and another field locktime 438 which have usual meanings. The input of the coinbase transaction represented by the coinbase transaction structure 430 includes an input field 434 which is empty and output fields 436 including block reward amount and public keys of block. Further, the coinbase transaction structure 430 includes flags fCoinBase flag 440 set to 1 and a flag fDebtTrans flag 442 set to 0 to indicate that the transaction represented by the transaction structure 430 is a coinbase transaction. The generation and management of coinbase transactions will be discussed late in conjunction with FIG. 12A.

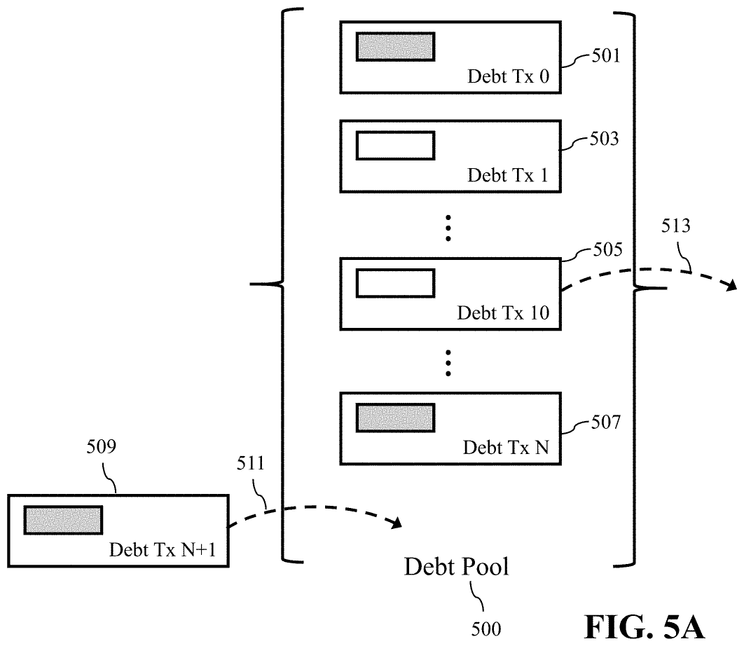

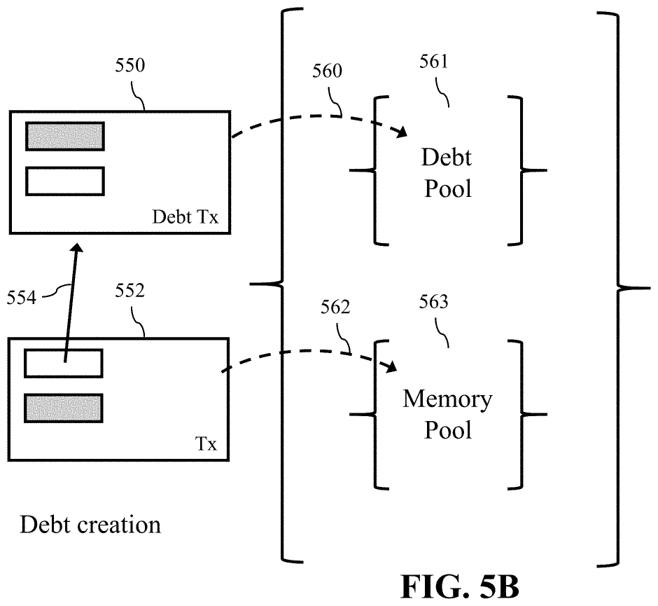

FIG. 5A shows an example of debt transactions in a debt pool 500 for managing unpaid debt transactions according to one embodiment. The debt pool 500 stores debt transactions 501, 503, and 507. When a new debt transaction 509 is created, it is placed 511 in the debt pool 500. The debt pool 500 contains all debt transactions that have not been fully repaid. Once a debt transaction 505 has been fully repaid, it is removed 513 from the debt pool 500. A fully repaid transaction 505 that is removed 513 from the debt pool, is considered a valid transaction by a protocol, and is therefore able to be included into blocks that comprise the blockchain

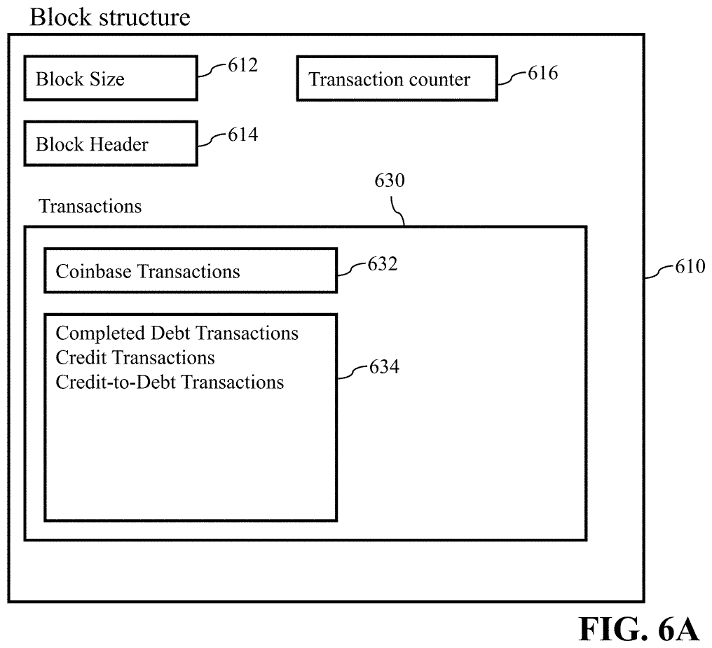

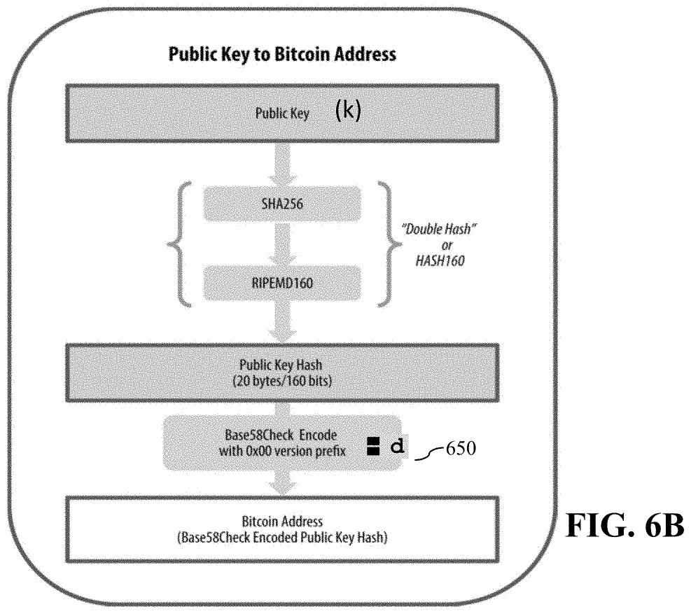

FIG. 5B shows the creation of a debt simultaneously with a credit according to one embodiment. In this embodiment, when a debt transaction 550 is created, a debt-credit transaction 552 is created simultaneously. The newly generated debt transactions are broadcast to other nodes and added 560 to a debt pool 561. The debt-credit transaction 552 that is created simultaneously, and which inputs points 554 to the debt transaction 550, is broadcasted to other nodes and added 562 to a memory pool 563 of the distributed ledger system. The addition and removal of debt transactions in the debt pool 500 will be described in detail later in conjunction with FIGS. 12B-12D. The various transactions described above may be configured to enable the implementation of the blockchain protocol for receiving messages and processing those messages into one or more blocks of a blockchain, wherein a message is associated with a transaction to be included in the blockchain by matching inputs and outputs of the transaction to neighboring transactions such that an input of the transaction is matched to an output of a previous transaction and an output of the transaction is matched to an input of a next transaction. While some structural description of the one or more blocks has already been discussed in FIG. 1A, more detailed explanation of the blockchain protocol and its associated block structure will be described in conjunction with FIG. 6A described below.

As previously discussed, distributed ledger systems are enabled by data structures known as the blockchain, which is a hash chain of blocks. The blockchain begins with a first, or genesis, block and each additional block in the blockchain contains a hash of the previous block. The structure of a block in a blockchain will be discussed in detail in conjunction with FIG. 6A.

FIG. 6A shows a structure of a block 610 of a blockchain structure according to some embodiments. The block includes a field for block size 612, a field denoting, in bytes, the size of the block 610. Further, the block 610 also includes a block header 614, a data structure that refers to the previous block and summarizes the current block.

The block header 614 includes a version number, which is used to track the version of the protocol (allows for upgrades to the protocol) used in the blockchain. It also includes a hash of the previous block, which links a block with the previous block. It also includes the Merkel root, the hash of the root of a Merkle tree, which is used as an integrity check for the transactions included in the block 610. Transactions in blockchain are stored in the form of binary hash trees or Merkle trees. The block header 614 also includes a timestamp of the creation time of the block. In some examples, there are additional fields in the block header 614. For example, in blockchain systems based on the Proof-of-Work (PoW) protocol, the block header 614 includes a difficulty target, set by the particular protocol which controls the time between blocks and a Nonce, a field used by PoW based protocols so that the hash of the current block satisfies the difficulty target. A block is considered valid if it satisfies a criterion as determined by the blockchain protocol. Examples of block validation criterion include block data structure being syntactically valid, i.e., they include the fields as defined in the protocol; the block timestamp is less than two hours in the future; the block size is within acceptable limits; the first transaction is the only coinbase transaction; or all transactions included in block are valid and the like. In PoW-based blockchain protocol, a block is considered valid if the hash of the block satisfies the difficulty target. On the other hand, transactions are considered valid if they satisfy certain implementation defined criteria. Examples of such criteria from a type of blockchain system, the Bitcoin, include the existence of a matching transaction in the memory pool, where the transaction size in bytes is less than a parameter called MAX_BLOCK_SIZE, which defines maximum size of a block and is an independent defined value, and a parameter called nLockTime, (which has also been discussed earlier in conjunction with FIGS. 1B-4B) is less than or equal to a value defined by a parameter INT MAX, among other criteria. Further, the block 610 also consists of a transaction counter 616, which is the count of transactions included in the block 610.

The next field in the block 610 is transactions 630. This field may be variable in size and may include, in some embodiments, a digital fingerprint of all transactions in the block 610. The transactions 630 may be one or more of Coinbase transactions 632 and other transactions 634, which include credit transactions, credit to debt transactions and completed debt transactions. For example, the transactions 630 may include the credit transaction 118, the debit transaction 120, the transfer transaction and the coinbase transaction 124 discussed in conjunction with FIG. 1A, transactions form the basis of a blockchain network and are carried out between one or more participants of the blockchain network.

Participants in the blockchain network are referred to as nodes. All nodes contain a copy of the blockchain, transactions, and in-memory data structures such as transaction pools. In a distributed ledger system, all nodes carry out the process of verifying transaction and the one or more blocks. If a transaction or block is valid, it may forward this to other nodes in the network. This is known as propagating blocks/transactions throughout the blockchain network. Though all nodes validate the correctness of blocks and transactions, only some specialized nodes finalize the transaction through the construction of blocks. These nodes are known as block-constructors and are responsible for constructing new blocks. They propose and construct new blocks that the nodes add to their copies of blockchain. Nodes conduct transactions which include transaction amounts and node identifiers. The various types of transactions that the nodes support have already been described earlier. The systems and methods disclosed herein are capable of providing debt transactions without having parent transaction as inputs, to be carried out using the blockchain protocol.

FIG. 6B shows an example of a schematic of a method that generates debt-only addresses using public keys according to some embodiments. Different embodiments used different implementations for denoting that the address is debt-only. For example, one embodiment implements the debt-only addresses by setting the Base58Check version prefix 650 to the value d in a Base58Check-based address generation system. That is, given a public key K, a corresponding debt address can be generated by setting:

### A=Base58CheckEncode(“d”,RIPEMD160(SHA256(K)))

In this example, credit addresses are generated in the appropriate manner.

In some UTXO-based protocols, addresses represent recipients of credits within the system. For example, the UTXO-based protocol can assign credit by specifying an address, which represents some recipient of the credit, in the locking script field of the transaction output. The addresses can represent a single participant. Additionally, or alternatively, the address can represent more complex conditions that must be met in order for the credit to be spent. The UTXO-based protocols may require that credit be spent via UTXOs from addresses that have sufficient credit, i.e., existing UTXOs.

In the debt-and-credit UXTO-based system disclosed in conjunction with the systems and methods of various embodiments, debt-only addresses are addresses that can send amounts without having any UTXO associated with the debt address. When a participant is deemed by the debt-and-credit UXTO-based system as having met the conditions for taking on debt, the debt-and-credit UXTO-based system then generates debt to assign to the associated address. An example of the conditions for taking on debt is through participation in the debit-and-credit network itself, which may constitute an implicit agreement for the network to assign debt to participants: consider the case of a central bank, which can generate credit at will by taking on effectively unlimited amounts of debt. Another example of the conditions for a participant to take on debt is for the participant to already own a certain amount of credits requested for debt: consider the case of fractional reserve banking, where the amount of debt owned by a bank is a multiple of the amount of credit owned by that bank.

In the debt-and-credit UTXO-based system, debts are implemented as transactions with unmatched transaction inputs, such as described in FIGS. 3A, 4A and 4B. The blockchain protocol associated with the debt-and-credit UXTO-based system disclosed herein first generates a debt transaction representing the debt. This is a transaction with no transaction inputs. The transaction outputs of this debt transaction are filled in accordance with the terms of the debt: the “amount” field in the output is the debt amount and the locking script includes the address of the recipient of the debt. The representation of debt in this manner provides an opportunity to provide direct representation of debt within a debt pool, such as illustrated in FIG. 5A.

The direct representation of debt within the blockchain protocol improves the integrity of the blockchain protocol. Alternative methods of implementing debt introduce additional complexity, which decreases the usefulness of the protocol and creates more potential for failure. A popular, decentralized method of implementing debt is using smart contracts, which are contracts enforced by computer code. Smart contracts are enabled by nodes that operate a protocol and interpret and compile a common programming language. An example of such a language is Solidity, which is used by the Ethereum blockchain. Solidity is not as versatile as other computer languages, such as C++, which is a limitation. Since the embodiments are not limited to any specific computer language, it can be applied to smart contracts written in C++ or any other programming language as desired. Using other mechanisms to represent debt adds unneeded complexity and requires additional and unnecessary computational resources, in the form of CPU cycles, computer memory, network bandwidth, etc. This is wasteful and can become a large problem when the blockchain becomes appreciable in size. On the contrary, in the debt-and-credit UXTO-based system disclosed herein, direct representation of debt within the system allows for manipulating debt within the system in a natural way.

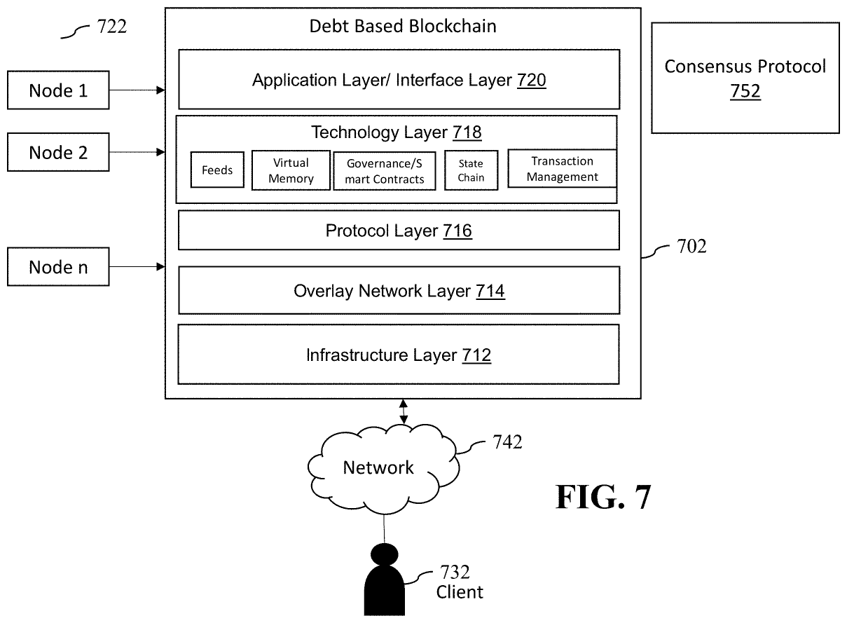

FIG. 7 shows an exemplary diagram illustrating a debt-and-credit UXTO-based system's debt based blockchain protocol stack for implementing debt in a distributed ledger system. The debt based blockchain protocol stack 702 comprises an infrastructure layer 212, an overlay network layer 714, a protocol layer 716, a technology layer 718, and an application layer 720. The blockchain protocol stack 702 may be in communication with various nodes 722 which may be configured for conducting various transactions as per a debt based blockchain protocol defined by the debt based blockchain protocol stack 702. The debt-based protocol may be used by the nodes 722, which may be users associated with a client 732 of the debt based blockchain protocol, wherein the client may be a service provider, a single user, a retail chain, a bank, a financial institution and the like. In some embodiments, the client 732 may be same as one or the nodes 722. To that end, the client 732 and the nodes 722 may be represented as a single entity.

The infrastructure layer 712 may be the physical interface layer which may be used for management of various devices and connections such as underlying connectivity devices, modems, routers, bus interface systems and the like. The overlay network layer 714 is used for implementation of a blockchain which acts as an overlay network over an existing network such as a network 742.

The protocol layer 716 may include a consensus protocol 752 module that may be used to establish a mechanism for establishing a consensus among various nodes 722, such as for updating the blockchain with the most updated copy of blocks. Apart from this, the protocol layer 716 may be used to cover various participation algorithms, virtual memory management, fault and recovery management functions and the like. The protocol layer 716 may include algorithms such as Proof-of-Work (POW), proof of elapsed time (POET), delegated proof of stake (DPOS), byzantine agreement (BA), proof of history (POH) and the like.

The technology layer 718 may be used to provide the various services as well to provide transaction management, management of credit and debt tokens, creation and management of debt pool and debt only addresses, keeping a record of transactions, such as input transaction and output transaction and the like. The technology layer 718 may additionally be used to provide functionalities for virtual memory management, blockchain update feed management, smart contracts, wallets, and the like.

The application layer 720 may be used to provide interface management functions for the debt based blockchain protocol. Some embodiments may be used to provide the application layer 720 including a browser management, such as for a dApp browser which may be used for decentralized applications, application hosting features and various user interface mechanisms. The application layer 720 may also be used in some embodiments for providing the distributed ledger system in a Software as a Service (SaaS) architecture to the client 732. The application layer 720 may also provide support for decentralized applications or dApps which may enable a client system to connect using a peer to peer server network on the blockchain network.

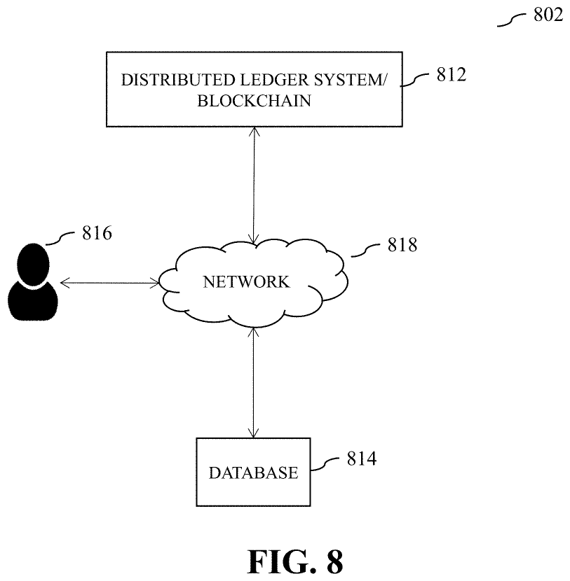

The debt based blockchain stack 702 may help to implement a distributed ledger system as described in conjunction with FIG. 8.

FIG. 8 shows a block diagram of distributed ledger system architecture 802 according to some embodiments. The distributed ledger system architecture 802 comprises a distributed ledger system 812, one or more databases 814, and a client 816, which are communicatively coupled through a network 818. The distributed ledger architecture 802 may be configured to implement the debt based blockchain protocol stack 702 described in FIG. 7. Thus, the distributed ledger system 812 may provide debt transaction and debt only addresses that are needed to provide debt based blockchain protocol stack 702. The distributed ledger system 812 may be referred to interchangeably hereinafter as the debt based distributed ledger system 812. The client 816 of the debt based distributed ledger system 812 may be any of one or more service providers that need to access the services of a blockchain enabled network. For example, the client 816 may include one or more of a financial service provider, a bank, a retail merchant, an energy services firm, a supply chain vendor, a manufacturing unit, a government or regulatory institution and the like. The client 816 may further include a plurality of customers or users of their services, which may act as participants or nodes of the debt based distributed ledger system 812. These nodes may be analogous to the nodes 722 discussed earlier in conjunction with FIG. 7, as users of the blockchain protocol stack 702, which is implemented by the debt based distributed ledger system 812 and can provide debt management functions. The debt based distributed ledger system 812 supports the transactions discussed earlier in conjunction with FIGS. 1A-4B and all of the features and components discussed in conjunction with debt management functions of a blockchain network as disclosed in FIGS. 5A-7.

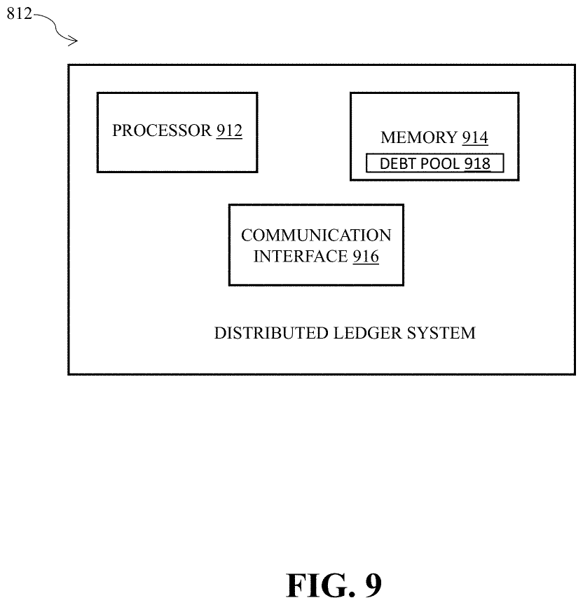

The debt-based distributed ledger system 812 may also include the database 814 which may be a database based on another architecture apart from the blockchain architecture, such as a relational architecture, and may include other information apart from client information, such as server information, third party resources, external regulatory and compliance related information and the like. All the components in the distributed ledger architecture 802 may be communicatively coupled over the network 818. The network 818 may be any of a wired or wireless network. The debt based distributed ledger system 812 will be described in more detail to provide an overview of the internal components in conjunction with FIG. 9.

FIG. 9 shows a block diagram of the debt based distributed ledger system 812 of FIG. 8 according to some embodiments. The distributed ledger system 812 comprises a processor 912, a memory 914 including a debt pool 918, and a communication interface 916.

The processor 912 can be a single core processor, a multi-core processor, a computing cluster, or any number of other configurations. The processor 912 is connected through a bus to one or more communication interface 916 systems such as I/O devices and hardware. The I/O devices may include any one of the following: a computer, a laptop, a handheld, a mobile device, a smartphone, a desktop, a PDA, a media device, a navigation equipment and the like.

The memory 914 can include random access memory (RAM), read only memory (ROM), flash memory, or any other suitable memory systems. The memory 914 includes the debt pool 918 which includes a record of all outstanding debt transactions in the debt based distributed ledger system 812. When a debt is repaid, its corresponding debt transaction is removed from the debt pool 918 and whenever debt is taken, a new transaction is added to the debt pool 918. Apart from debt transactions, the memory may also be configured to keep a record of all other transactions, such as credit transactions, debt credit transactions and the like. These transactions may be stored in a memory pool, as discussed in conjunction with FIG. 5B. The memory pool and debt pool may be stored as separate units in the memory 914 in some embodiments.

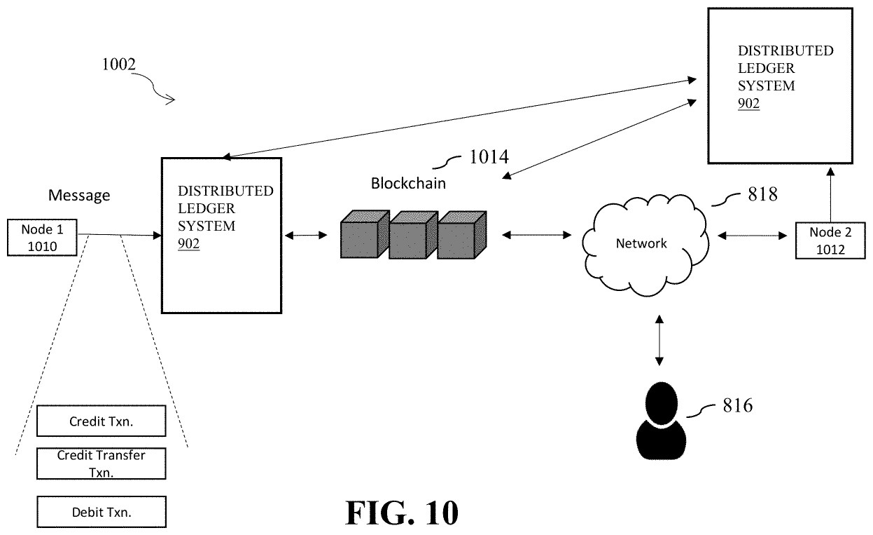

FIG. 10 shows an exemplary architecture of a debt-based distributed ledger system 1002 according to some embodiments. The distributed ledger system 1002 with debt management features comprises nodes 1010 and 1012, each having a copy of their own distributed ledger 902, and also communicatively coupled to a blockchain overlay network 1014. The distributed ledger system 1002 also includes the network 818 and the client 816. The number of nodes shown in the distributed ledger system 1002 is two only for exemplary purpose, while any number of nodes can be added to the distributed ledger system 1002 without deviating from the scope of different embodiments. The nodes 1010 and 1012 may be used to communicate with each other using the debt based blockchain protocol as discussed in FIG. 8. For example, the node 1010 may be configured to transmit messages to the debt based distributed ledger system 902 which may be configured to receive and process those messages in order to provide debt management using the distributed ledger system 1002. In some embodiments the distributed ledger system 1002 and debt-based distributed ledger system 902 may be same.

The nodes 1010 and 1012 may be configured to carry out the various transactions described above, for example the debt transaction 310 or 410, the partially repaid debt transaction 350, the unspent debt credit transaction 370, or even the coinbase transaction 430. Using these transactions, the distributed ledger system 1002 may be configured to provide debt management.

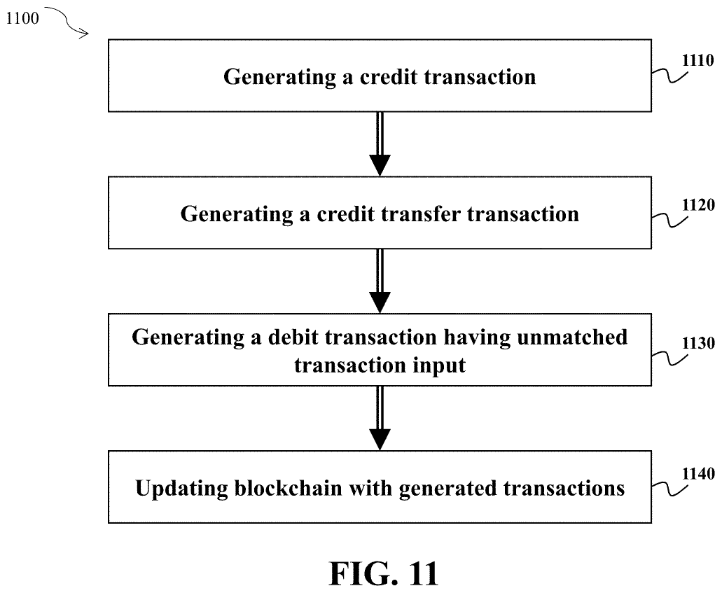

FIG. 11 shows an exemplary block diagram of a method 1100 for debt management in a distributed ledger system according to some embodiments. The method 1100 includes, at 1110, generating a credit transaction. For example, the credit transaction may be same as a credit transaction in a UTXO based system. The credit transaction may have both an input and an output, where the input may point to a sender of credit and the output may point to the recipient of the credit. The method may further include, at 1120, generating a credit transfer transaction. The credit transfer transaction may be a transaction involving at least two nodes, such as nodes 1010 and 1012. The transfer of credit may take place from node 1010 to node 1012, by mentioning the address of the node 1010 in the input field of a credit transaction received at the node 1012, and mentioning the address of the node 1012 in the output field of the corresponding debit transaction originating at the node 1010. A special case of credit transfer may be when the node 1010 does not have sufficient credit or spendable UTXO amount available and thus, needs to take a debt for performing this credit transfer. In this case, at 1130, a debit transaction is generated having no parent transaction as input. If the node 1010 needs debt, then the output of the debit transaction generated at 1130 points to the node 1010. At the same time, the generated debt transaction may be added to a debt pool, such as the debt pool 500. Further, once the corresponding transactions are generated, the blockchain system, such as the debt based distributed ledger system 902, may be, at 1140, updated with the generated transactions. Additionally, or alternatively, the distributes ledger system 902 may also include exchanging various messages describing a sequence of events associated with the coinbase transactions, as described further with reference to FIGS. 12A to 12D.

FIG. 12A shows an exemplary block diagram of a method 1200 describing the sequence of events that occur in embodiments of blockchain systems with coinbase transactions that are accepted by the network. Such embodiments can occur, for example, in mining-based blockchain systems. When the coinbase transaction, such as the coinbase transaction 124 described in FIGS. 1A and 4B is generated, the method 1200 may include, at step 1201, validating the one or more blocks associated with the coinbase transaction. When a block satisfies the validation criterion, at 1203, it is accepted by the network. Further, the validated block or the validated one or more blocks are then, at 1205, propagated to all nodes in the network. Since coinbase transactions are transactions with unmatched inputs and outputs, the output, a UTXO representing a credit transaction, is, at 1207 moved into the memory pool of each node, that is to say, the UTXO data structure is stored in the memory pool of each of the one or more nodes. Once in memory pool the coinbase reward is then available for spending by the recipient that is able to solve the unlocking script in the UTXO.

FIG. 12B shows an exemplary block diagram of a method 1210 describing the sequence of events that occur when a debt transaction is generated. This begins, when at 1211 a user initiates a request to generate debt. In some embodiments, the act of requesting permission can be the act of attempting to initiate a debt transaction wherein the protocol decides whether the user has enough permissions to do so. Other possible embodiments may include a node with special privileges that the user must engage with to obtain permission. Once permission is verified by the user at 1213, then at, 1215, the debt-transaction is generated along with the debt-credit transaction and at, 1215, is propagated to the network. Each node then adds the debt-transaction to their debt pools, at 1217. The debt-credit transaction is a valid credit-transaction and is a candidate for inclusion into a block. Thus, at 1219, the valid transactions are associated with corresponding blocks. Only after proper association, the blocks are recorded on the blockchain by inclusion of the transaction in the blocks on the blockchain. Further at 1220, the output of the debit-credit transaction gets moved to a memory pool by all nodes.

FIG. 12C shows an exemplary block diagram of a method 1240 describing the sequence of events that occur when a debt transaction is paid. In some embodiments, a user may decide to repay some debt and does this by sending a credit transaction containing an amount less than the total outstanding debt in the debt transaction to the debt transaction by specifying the hash of debt transaction in the locking script. When such a transaction exchange happens, the distributed ledger system may be configured to carry out the sequence of events described in method 1240 beginning at 1241, by checking if the sending address matches a debt-only address. Once, the debt only address has been checked, at 1243, this is broadcast to a plurality of nodes in the network. Upon receipt of this credit repayment transaction the plurality of nodes may, at 1245, perform checking of the locking script to determine whether the address matches the hash of a debt transaction in their respective debt pools. If so, then at 1247, the method includes replacing the locking script of the credit (repayment) UTXO with the debt-only address and recording the credit-repayment UTXO as an input to the debt-transaction 1247 from which the credit ultimately originated, which is in the corresponding node's debt pool. After this, at 1249, the method includes checking whether the debt is totally repaid by summing the amounts contained in the input and comparing it to the sum of the amounts in the output. If the sum of the input is less than the sum of the output, then, at 1251, nothing is done. The edited credit repayment transaction, on each node, is then a valid transaction that is a candidate for inclusion into a block. Finally, at 1253, the repayment is considered permanent when it is included into a block that is successfully accepted by the network and becomes a part of the blockchain.

FIG. 12D shows an exemplary block diagram of the sequence of events of a method 1260 that occur when a debt transaction is completely paid off. The method 1260 includes, at 1261, determining a difference between a first amount associated with the debt transaction and a second amount obtained by summing individual amounts associated with each parent transaction of a plurality of parent credit transactions. Further, at 1263, an output amount equal to the difference may be generated. In some embodiments, the difference amount may be specified in the amount and the change address specified in the locking-script, thereby making the sum of the input equal to the sum of the output. Then the blockchain protocol may recognize that the debt-transaction as being repaid and the debt-transaction is then recognized as being a valid transaction and becomes a candidate for inclusion into a block. Thus, at 1265, the generated repaid debt-transaction associated with the repaid output amount is sent for association and thus inclusion in the one or more blocks. 1265. Once the debt-transaction has been recorded in the blockchain by inclusion into an accepted block, then at 1267, the debt-transaction is then removed from the debt pool.

Some embodiments provide permission-based creation of debt transactions, so that overall debt in the debt based distributed ledger system 902 may be managed easily and also the repayment of debts can be ensured. Further, the permissions may be granted at the time of creation of a new debt transaction, by referring to the debt transactions already in the debt pool. Some embodiments provide that the permission is managed internally by the debt based distributed ledger system 902. Some embodiments may also provide an external agency or third party for managing permissions for creation of new debt transactions. By generation and management of debt in the various embodiments descried above, the systems and methods disclosed herein may offer various advantages over the UTXO-based systems.

The various technical advantages of the systems and methods disclosed in the paragraphs above are apparent by the various methodologies described above. Specifically, the system and methods disclosed for the representation of debt in distributed ledgers, which overcome the limitations of distributed ledgers systems which lack such a capability. The methodologies described herein have been discussed in terms of credit and debit tokens for an exemplary purpose, however, a token as a unit of exchange if the distributed ledger system described herein may be contemplated to be of use in various application areas without deviating from the spirit and scope of the present disclosure.

The distributed debt management system described above may be used for various types of applications, including, but not limited to energy sector, financial institutions, banks, retail applications, real-estate applications, inventory tracking in supply chain systems and the like.

The blockchain-based distributed ledger system for debt management described above may be used for trading of energy units. The credit and debit tokens may be used to represent a datum of energy consumed or energy needed respectively, and may be traded using the distributed ledger system 802. The credit token may be used to estimate the billing and metering functions of energy consumption, while the debit token may be used for representing bill payment, bidding, demand estimation functions and the like in the energy sector. The blockchain-based distributed ledger system 802 may also be used for other allied functions in the energy sector such as decentralized energy trading, carbon trading, rewards and incentives in the form of green certificates, grid and micro-grid management, IoT based smart automation in energy solutions, user centric and user defined smart contracts, electric e-mobility and the like.

The blockchain-based distributed ledger system 802 may also be used in supply chain management solutions for inventory tracking and management. Each item of inventory may be associated with an identifier and may be stored, protected, and tracked using the blockchain based distributed ledger system 802.

The blockchain-based distributed ledger system 802 may also be used to implement a rewards and incentive based loyalty solution, which may be used in various sectors, such as retail, banking, online shopping, mobile payments and the like. The debt tokens may additionally be used to represent reward coupons generated by a retail chain supplier which may be redeemed by their customer at the time of conducting purchase transactions.

The blockchain-based distributed ledger system 802 may further be used in food technology sector for quality management, certification, regulatory requirements management and the like. Each time a food safety norm is breached by a client, they may be issued penalty tokens in the form of debt tokens, which they would have to repay after a penalty threshold is reached, before conducting further transactions. These and other such applications in the food technology sector may help in quality assurance, quality management and ensuring transparency in the food technology sector.

The blockchain based distributed ledger system 902 may also be used for medical record keeping and maintaining doctor reputation and feedback related activities for ensuring availability of a robust medical ecosystem. These and other applications of the blockchain based distributed ledger system 802 may be implemented by a person of ordinary skill in the art.

This description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in this description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

We claim:

1. A distributed ledger system, comprising:
at least one processor configured to execute instructions to implement a blockchain protocol for receiving messages and processing those messages into one or more blocks of a blockchain, wherein a message is associated with a transaction to be included in the blockchain by matching inputs and outputs of the transaction to neighboring transactions such that an input of the transaction is matched to an output of a previous transaction and an output of the transaction is matched to an input of a next transaction, wherein during processing of the messages, the processor is configured carry out operations to generate different types of transactions including:
a credit transaction having an unmatched output configured for matching to the next transaction;
a debit transaction having an unmatched input configured for matching to the previous transaction; and
a transfer transaction having a matched input and a matched output.

2. The distributed ledger system of claim 1, wherein the processor is further configured to carry out the operations to:
generate a coinbase transaction associated with one or more blocks of the blockchain protocol;
validate the one or more blocks of the generated coinbase transaction based on a validation criterion;
accept the one or more blocks of the generated coinbase transaction in the blockchain protocol based on the validation;
propagate the one or more blocks of the generated coinbase transaction to a plurality of nodes associated with the blockchain; and
store a UTXO associated with the transmitted one or more blocks to a memory pool of each node of the plurality of nodes.

3. The distributed ledger system of claim 1, wherein the processor is further configured to carry out the operations to:
initiate creation of a debt transaction;
verify the debt transaction based on one or more permissions associated with the creation of the debt transaction;
generate a debt credit transaction associated with the debt transaction;
propagate the debt transaction and the debt credit transaction to a plurality of nodes associated with the blockchain protocol; and
associate the transmitted debt transaction and the debt credit transaction with a corresponding block in the blockchain protocol

4. The distributed ledger system of claim 1, wherein to execute the blockchain protocol, the processor is further configured to carry out the operations to keep all outstanding debts in the distributed ledger system in a debt pool of each node of the plurality of nodes.

5. The distributed ledger system of claim 4, wherein to execute the blockchain protocol, the processor is further configured to carry out the operations to remove debit transactions associated with outstanding debts from the debt pool after the debt transaction has been assigned an input pointing to a credit transaction.

6. The distributed ledger system of claim 4, wherein to execute the blockchain protocol, the processor is further configured to carry out the operations to populate the input of the debt transaction with multiple parent credit transactions.

7. The distributed ledger system of claim 5, wherein to execute the blockchain protocol, the processor is further configured to carry out the operations to:
determine a difference between a first amount associated with the debt transaction and a second amount associated with the multiple parent credit transactions, wherein the second amount is obtained by summing individual amounts associated with each parent transaction of the multiple parent credit transactions;
generate a repaid debt transaction associated with the output amount;
propagate the repaid debt transaction to one or more blocks associated with the debit transaction;
verify the repaid debt transaction based on a validation criterion associated with the one or more blocks; and
remove the repaid debt transaction from the debt pool based on satisfaction of the validation criterion.

8. The distributed ledger system of claim 1, wherein
the distributed ledger system is operatively coupled to a client, and
the client is configured to broadcast debt transactions to a network.

9. The distributed ledger system of claim 1, wherein the debt transaction is associated with a debt-only address.

10. The distributed ledger system of claim 1, wherein the debt transaction comprises a locking script specifying conditions required to be satisfied by an output of the debit transaction.

11. The distributed ledger system of claim 10, wherein the conditions are associated with a criterion that allows the output to be spent.

12. A method for distributed ledger, wherein the method uses at least one processor configured to execute a blockchain protocol for receiving messages and processing those messages into one or more blocks of a blockchain, wherein a message is associated with a transaction to be included in the blockchain, wherein during processing of the messages, the processor is configured to generate different types of the transactions of the method, comprising:
generating a credit transaction having an unmatched output configured for matching to the next transaction;
generating a debit transaction having an unmatched input configured for matching to the previous transaction; and
generating a transfer transaction having a matched input and a matched output.

13. The method of claim 12, further comprising:
generating a coinbase transaction associated with one or more blocks of the blockchain protocol;
validating the one or more blocks of the generated coinbase transaction based on a validation criterion;
accepting the one or more blocks of the generated coinbase transaction in the blockchain protocol based on the validation;
propagating the one or more blocks of the generated coinbase transaction to a plurality of nodes associated with the blockchain protocol; and
storing a UTXO associated with the transmitted one or more blocks to a memory pool of each node of the plurality of nodes.

14. The method of claim 12, further comprising:
initiating creation of a debt transaction;
verifying the debt transaction based on one or more permissions associated with the creation of the debit transaction;
generating a debt credit transaction associated with the debit transaction;
propagating the debt transaction and the debt credit transaction to a plurality of nodes associated with the blockchain protocol; and
associating the transmitted debt transaction and the debt credit transaction with corresponding block in the blockchain protocol.

15. The method of claim 12, further comprising keeping all outstanding debts in the distributed ledger system in a debt pool.

16. The method of claim 15, further comprising removing debt transactions associated with outstanding debts from the debt pool after the debt transaction has been assigned an input pointing to a credit transaction.

17. The method of claim 14, further comprising populating the input of the debt transaction with multiple parent credit transactions.

18. The method of claim 17, further comprising:
determining a difference between a first amount associated with the debt transaction and a second amount associated with the multiple parent credit transactions, wherein the second amount is obtained by summing individual amounts associated with each parent transaction of the multiple parent credit transactions;
generating a repaid debt transaction associated with the output amount;
propagating the repaid debt transaction to one or more blocks associated with the debt transaction;
verifying the repaid debt transaction based on a validation criterion associated with the one or more blocks; and
removing the repaid debt transaction from the debt pool based on satisfaction of the validation criterion.

19. The method of claim 13, wherein address associated with the debt transaction is a debt-only address.

20. The method of claim 13, wherein debit transaction comprises a locking script specifying a debtor that corresponds to the locking script that contains conditions required to be satisfied by the output, and wherein the conditions are associated with a criterion that allows the output to be spent.
